(19) United States
(12) Patent Application Publication
(10) Pub. No.: US 2025/0392734 A1
(43) Pub. Date: Dec. 25, 2025

(54) TEMPLATE MATCHING FOR GEOMETRIC PARTITIONING FOR MOTION PREDICTION

(71) Applicant: Alibaba (China) Co., Ltd., Hangzhou (CN)

(72) Inventors: Jie Chen, Beijing (CN); Yeping Zheng, Hangzhou (CN); Xinwei Li, Beijing (CN); Ru-ling Liao, Sunnyvale, CA (US); Yan Ye, San Diego, CA (US)

(21) Appl. No.: 19/096,681

(22) Filed: Mar. 31, 2025

Related U.S. Application Data
(60) Provisional application No. 63/662,241, filed on Jun. 20, 2024.

(51) Int. Cl. H04N 19/176; H04N 19/119; H04N 19/167; H04N 19/567

(52) U.S. Cl. CPC H04N 19/176; H04N 19/119; H04N 19/167; H04N 19/567

(57) ABSTRACT

A VVC-standard encoder and a VVC-standard decoder are provided, configuring one or more processors of a computing system to perform template matching for geometric partitioning, including extensions of template size for template matching, application of blending at a splitting line, reordering of partitioning modes by template matching cost and blending area width, and bitstream signaling of blending area width.

### PRIORITY

This patent application claims priority to U.S. Provisional Patent Application No. 63/662,241, filed on Jun. 20, 2024, entitled “IMPROVED TEMPLATE MATCHING FOR GEOMETRIC PARTITIONING FOR MOTION PREDICTION,” and is fully incorporated by reference herein.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name and the Joint Exploration Model (“JEM”) name.

According to the VVC standard, an encoder and a decoder partition picture data into blocks, and perform motion prediction upon luma and chroma components of the blocks by selecting one among various intra prediction and inter prediction modes. The VVC standard provides Geometric Partitioning Mode (“GPM”), where, to efficiently code boundaries and edges of objects in a picture, any particular block of a picture can be internally partitioned into two irregular partitions by a partitioning line spanning two edges of the block. GPM provides for predefined sets of unique internal partitioning modes of blocks and sub-blocks of various dimensions, enabling boundaries and edges in a picture to be described accurately in a granular manner.

Moreover, at time of writing, the latest draft of ECM (presented at the 32nd meeting of the JVET in October 2023 as “Algorithm description of Enhanced Compression Model 11 (ECM 11)”) extends GPM to adopt techniques such as adaptive blending, adaptive matching, and affine motion compensation.

In particular, there is a need to further improve the implementation of adaptive blending in GPM as provided by ECM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates classifications of geometric partitions by angle.

FIG. 3 illustrates an example blending weight wo derived for position (x, y).

FIG. 4 illustrates ramp functions for additional adoptive blending area widths based on the ramp function of an original blending area width.

FIG. 5 illustrates an example of extending a partition splitting line of a current coding block.

FIGS. 6A through 6C illustrate respective examples of the available IPM candidates.

FIG. 6D illustrates GPM with intra and intra prediction.

FIG. 7 illustrates extension of a template for template matching according to example embodiments of the present disclosure.

FIG. 8A illustrates blending for geometric partitioning according to VVC and ECM.

FIG. 8B illustrates template blending at a splitting line according to example embodiments of the present disclosure.

FIG. 9 illustrates a flowchart of reordering partitioning modes according to VVC extended by ECM.

FIG. 10 illustrates a flowchart of reordering partitioning modes by a VVC-standard encoder according to example embodiments of the present disclosure.

FIG. 11 illustrates a flowchart of reordering partitioning modes by a VVC-standard decoder according to example embodiments of the present disclosure.

FIG. 12 illustrates an example system for implementing the processes and methods described herein for implementing template matching for geometric partitioning.

### DETAILED DESCRIPTION

Systems and methods discussed herein are directed to implementing template matching for geometric partitioning for motion prediction, and more specifically extensions of template size for template matching, application of template blending at a splitting line, reordering of partitioning modes by template matching cost and blending area width, and bitstream signaling of blending area width.

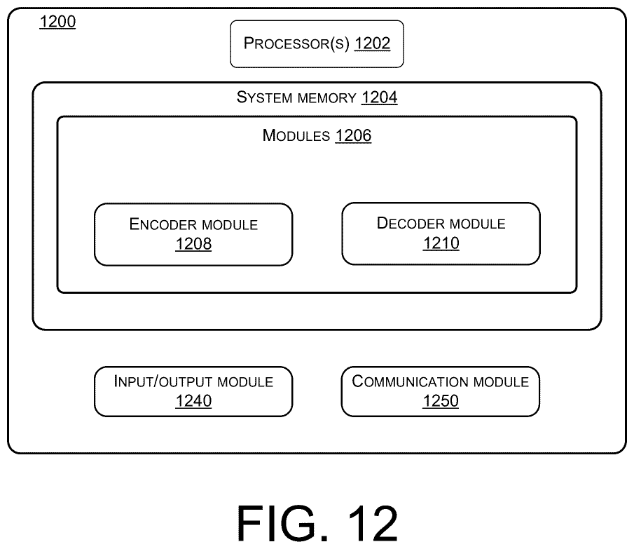

In accordance with the VVC video coding standard (the “VVC standard”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 12, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

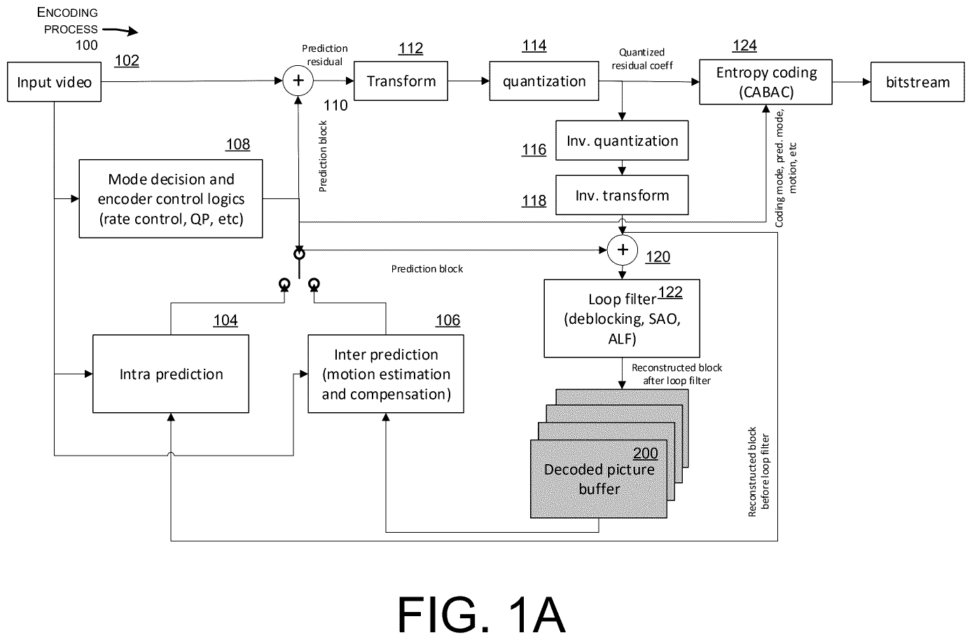

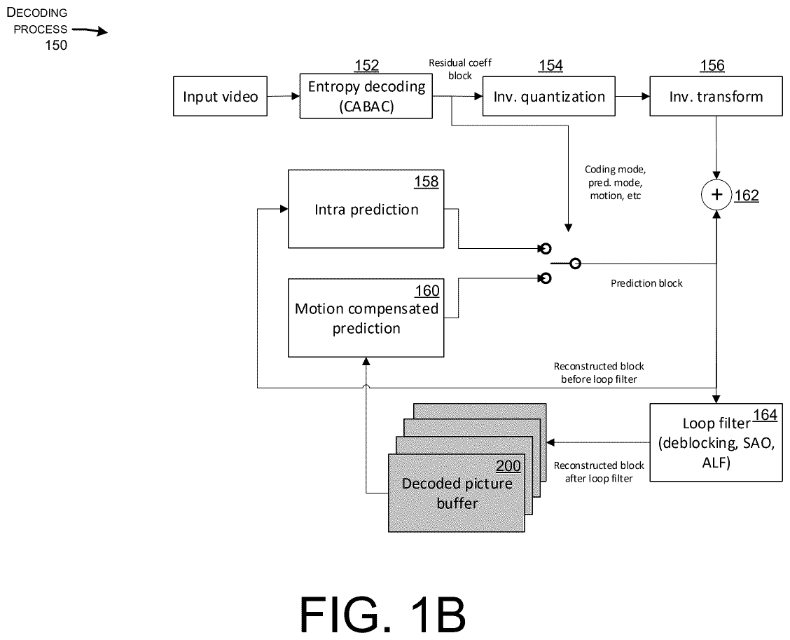

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which can be further subdivided into partitions. A VVC-standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, a VVC-standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to the VVC standard. Motion information corresponding to a PU can describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CU to include reference indices to identify, for reference of a VVC-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC-standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured to perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder. The bitstream is written by one or more processors of a computing system to a non-transient or non-transitory computer-readable storage medium of the computing system, for transmission.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

VVC further provides that blocks and sub-blocks of a picture can further be partitioned according to geometric partitioning for inter prediction. Square or non-square blocks and sub-blocks of size having dimensions of at least 8 luma samples to each side can be partitioned according to geometric partitioning. A partitioning mode of a block or sub-block according to geometric partitioning can be indicated by a straight partitioning line spanning a first coordinate of a first side of the block or sub-block and a second coordinate of a second side of the block.

Based on the position of the first coordinate and the position of the second coordinate, as well as orientation of the first side and orientation of the second side, an angle of the partitioning line as drawn from the first coordinate to the second coordinate, and a distance of the partitioning line as spanning the first coordinate and the second coordinate, are characterized. The angle of the partitioning line and the distance of the partitioning line can further classify the partitioning mode as one of multiple template partitioning modes which can be specified according to implementations of geometric partitioning.

Geometric partitioning modes (“GPMs”) are signaled using a CU-level flag as one kind of merge mode among other possible merge modes including the regular merge mode, merge with motion difference (“MMVD”) mode, the CIIP mode and the subblock merge mode. In total, 64 partitions are supported by geometric partitioning mode for each possible CU size.

The location of the splitting line is mathematically derived from the angle and offset parameters of a specific partition. Each part of a geometric partition in the CU is inter-predicted using its own motion; only uni-prediction is allowed for each partition, i.e., each part has one motion vector and one reference index. The uni-prediction motion constraint is applied such that, similar to conventional bi-prediction, only two motion compensated predictions are needed for each CU.

After predicting each of part of the geometric partition, the sample values along the geometric partition splitting line are adjusted using a blending processing with adaptive weights. This is the prediction signal for the whole CU, and transform and quantization process will be applied to the whole CU as in other prediction modes.

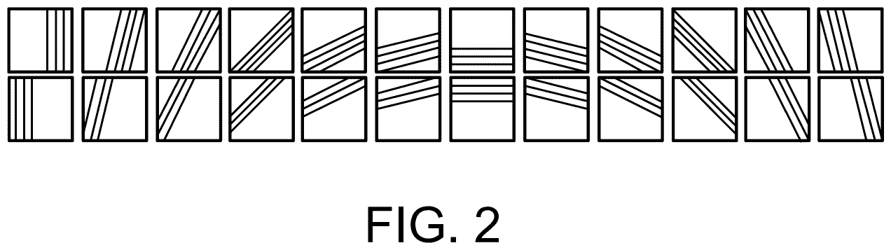

FIG. 2 illustrates classifications of geometric partitions by angle. For each classification, the splitting line always has the same angle but can be at various different coordinates, where each classification is illustrated showing, by way of example, three among many possible coordinates.

According to VVC, a first motion vector (“Mv1”) from the first part of the geometric partition, a second motion vector (“Mv2”) from the second part of the geometric partition, and a combined motion vector (“Mv”) of Mv1 and Mv2 are stored in the motion filed of a geometric partitioning mode coded CU.

The stored motion vector type (“sType”) for each individual position in the motion filed are determined by Equation 1 below:

$$sType = abs ( motionIdx ) < 32 ? 2 : ( motionIdx \leq 0 ? ( 1 - partIdx ) : partIdx )$$

In the equation for determination of motion vector type, motionIdx is equal to d(4x+2, 4y+2).

If sType is 0 or 1, Mv0 or Mv1 are stored in the corresponding motion field. Otherwise, if sType is 2, a combined Mv from Mv0 and Mv2 are stored.

The combined Mv from Mv0 and Mv2 are generated based on first checking if Mv1 and Mv2 are from different reference picture lists (i.e., one from list 0 and the other from list 1). If so, Mv1 and Mv2 are combined to form the bi-prediction motion vectors. Otherwise, if Mv1 and Mv2 are from the same list, only uni-prediction motion Mv2 is stored.

According to VVC, after predicting each part of a geometric partition by reference to its own motion, blending is applied to the two prediction signals to derive samples around geometric partition splitting line. The blending weight for each position of the CU are derived based on the distance between individual position and the partition splitting line. Given indices for angle and offset of a geometric partition (represented as i, j), which depend on the signaled geometric partition index, the distance for a position (x, y) to the partition splitting line is derived according to Equation 2, Equation 3, and Equation 4 below:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {ρ}_{y , j} sin ( {φ}_{i} )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix}$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix}$$

The sign of p_{x,j} and p_{y,j} depend on angle index i. The weights for each part of a geometric partition are derived according to Equation 5 and Equation 6 below:

$$wIdxL ( x , y ) = partIdx ? 32 + d ( x , y ) : 32 - d ( x , y )$$

$${w}_{0} ( x , y ) = \frac{Clip 3 ( 0 , 8 , ( wIdxL ( x , y ) + 4 ) ≫ 3 )}{8}$$

$${w}_{1} ( x , y ) = 1 - {w}_{0} ( x , y )$$

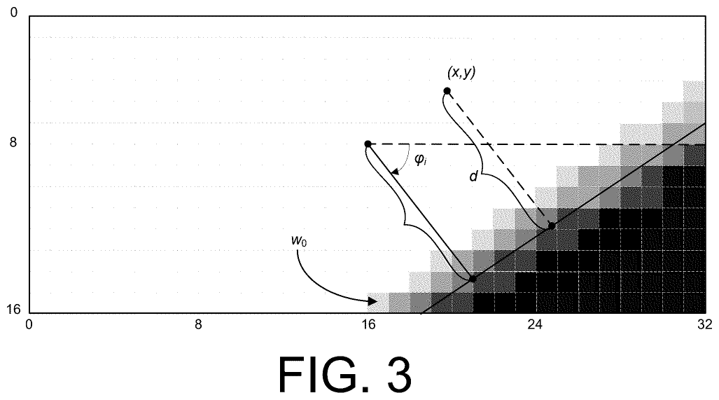

The partIdx depends on the angle index i. FIG. 3 illustrates an example blending weight wo derived for position (x, y).

According to VVC, final prediction samples are generated by blending the prediction of the two prediction signals using weighted average. Two integer blending matrices (W0 and W1) are used, where weights in the GPM blending matrices are derived from the ramp function based on the displacement d from a predicted sample position to the GPM splitting line. The blending area width t is fixed to two (taking two samples on each side of the GPM partition splitting line).

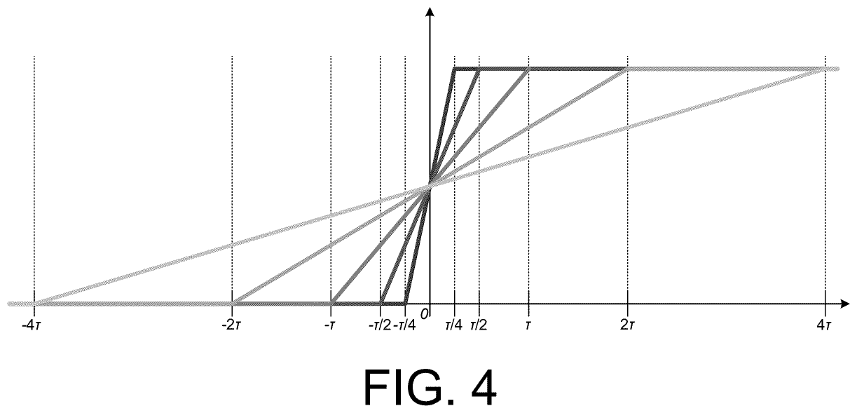

According to ECM, adaptive blending is further adopted for geometric partitioning. Specifically, besides the existing blending area, additional blending area widths, i.e., quarter, half, double, and quadruple of the existing area width (τ/4, τ/2, 2τ, and 4τ), are added. FIG. 4 illustrates ramp functions for additional adoptive blending area widths based on the ramp function of an original blending area width.

The selected blending area width is signaled at CU-level from encoder to decoder. Furthermore, the extended weighting precision is proposed, that is the maximum value of the weighs is changed from 8 to 32 to accommodate the extended blending area widths.

The weights for a geometric partition and the prediction pixel are derived (based on A(x, y) and B(x, y) representing the prediction sample values at the coordinate (x, y) within the block referred by MV0 and MV1 prediction) by Equation 7 and Equation 8 below:

$$w ( x , y ) = \{ \begin{matrix}0 & d ( x , y ) \leq - {α}_{i} τ \\ \frac{32}{2 {α}_{i} τ} ( d ( x , y ) + {α}_{i} τ ) & - {α}_{i} τ \leq d ( x , y ) \leq {α}_{i} τ \\ 32 & d ( x , y ) \geq {α}_{i} τ\end{matrix}$$

$$p ( x , y ) = ( w ( x , y ) * A ( x , y ) + ( 32 - w ( x , y ) ) * B ( x , y ) + 16 ) ≫ 5$$

In template matching (“TM”) based reordering for GPM split modes, template matching is performed by searching, in a predefined search range, based on an L-shaped template of the current block, for an L-shaped template in a reference picture having the least difference from the template of the current block (expressed by lowest cost according to a cost function). Given the motion information of the current GPM block, the respective template matching cost values of GPM split modes are computed. Then, all GPM split modes are reordered in order of ascending TM cost values. Instead of sending GPM split mode, an index using Golomb-Rice code to indicate where the exact GPM split mode located in the reordering list can be signaled.

GPM split mode reordering is a two-step process performed after the respective templates of reference pictures of the two GPM partitions in a coding unit are generated. The first step is extending GPM partition splitting line into templates of reference pictures of the two GPM partitions, resulting in 64 reference templates and computing the respective TM cost for each of the 64 reference templates. The second step is reordering GPM split modes based on their TM cost values in ascending order and marking the best 32 split modes as available split modes.

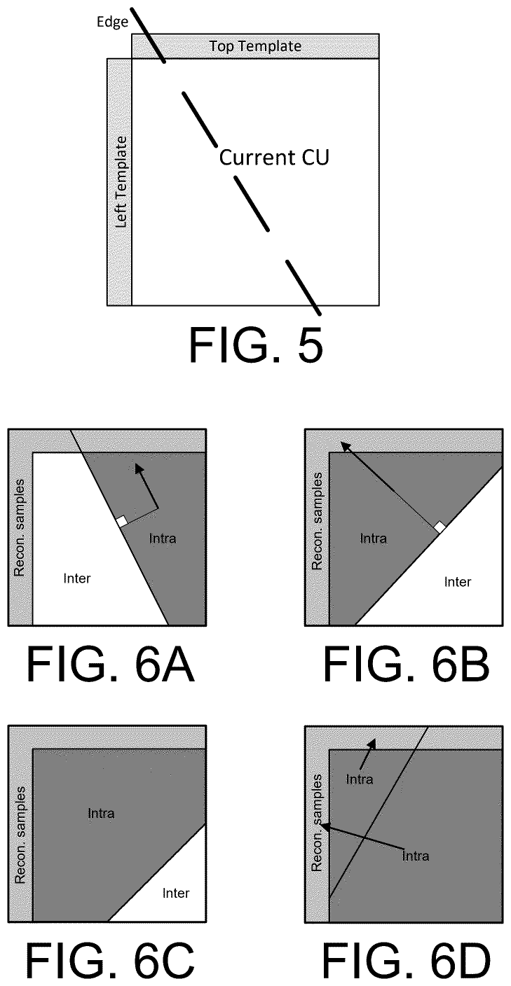

The splitting line over the template is extended from that of the current coding block. FIG. 5 illustrates an example of extending a partition splitting line of a current coding block. However, the GPM blending process is not applied in the template area across the splitting line. After reordering in ascending order of TM cost, an index can be signaled using Golomb-Rice code (with divisor 4) to indicate the use of GPM split mode, as listed in Table 1 below:

Binary code

| Index | Prefix | Suffix |
|---|---|---|
| 0-3 | 0 | 00-11 |
| 4-7 | 10 | 00-11 |
| 8-11 | 110 | 00-11 |
| . . . | . . . | . . . |
| 28-31 | 1111 111 | 00-11 |

When GPM mode is enabled for a CU, a CU-level flag is signaled to indicate whether template matching is applied to both geometric partitions. Motion information for each geometric partition is refined using template matching. When template matching is chosen, a template is constructed using neighboring samples left of the current coding block, neighboring samples above the current coding block, or neighboring samples both left and above the current coding block according to partition angle, according to Table 2 below.

| | Partition angle | | | | | | | | | |
|---|---|---|---|---|---|---|---|---|---|---|
| | 0 | 2 | 3 | 4 | 5 | 8 | 11 | 12 | 13 | 14 |
| 1^{st} partition | A | A | A | A | L + A | L + A | L + A | L + A | A | A |
| 2^{nd} partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

The motion is then refined by minimizing the difference between the template of the current coding block and the template of the reference picture using the same search pattern of merge mode with half-pel interpolation filter disabled.

A GPM motion candidate list is then constructed. First, MV candidates for list 0 and list 1 are derived directly from a regular merge candidate list and interleaved. List 0 candidates are higher priority candidates than list 1 candidates. A pruning method with an adaptive threshold based on the current coding block size is applied to these interleaved list 0 and list 1 MV candidates to remove redundant MV candidates. Then, further list 0 and list 1 candidates are derived from the regular merge candidate list, but list 1 MV candidates are higher priority than list 0 MV candidates. The same pruning method with the same adaptive threshold is then applied once more to remove redundant MV candidates. Finally, Zero MV candidates are inserted as padding until the GPM motion candidate list is full.

One GPM CU cannot use both MMVD and TM with GPM; GPM-MMVD and GPM-TM are mutually exclusive. This is enforced by signaling the GPM-MMVD syntax first in a bitstream, followed by the GPM-TM flag. When both GPM-MMVD control flags are equal to false (i.e., the GPM-MMVD are disabled for two GPM partitions), the GPM-TM flag is signaled to indicate whether template matching is applied to the two GPM partitions. Otherwise, when at least one GPM-MMVD flag is equal to true, the value of the GPM-TM flag is inferred to be false.

The VVC standard extends GPM by applying motion vector refinement on top of the existing GPM uni-directional MVs. In a bitstream, a flag is first signaled for a GPM CU to specify whether motion vector refinement mode is applied. If motion vector refinement mode is applied, motion vector difference (“MVD”) can be signaled or not signaled for each geometric partition of a GPM CU. For each geometric partition for which MVD is signaled, after a GPM merge candidate is selected, the motion of the partition is further refined by the signaled MVD information. All other steps are kept the same as in GPM.

The MVD is signaled as a distance-direction pair, similarly to MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) applicable in GPM-MMVD. In addition, when pic_fpel_mmvd_enabled_flag has a value of 1, the MVD is left shifted by 2 as in MMVD.

In the VVC standard, GPM relies on uni-predictive motion vectors to generate motion compensated prediction samples for each inter GPM partition. ECM extends the VVC standard to allow usage of bi-predictive motion vectors for GPM.

When constructing a GPM motion candidate list, extraction of uni-predictive motion vectors from the initial merge list is invoked only for small blocks 8×8, 16×8 and 8×16. For larger blocks, extraction is bypassed, so the initial merge list (which May contain merged Bi-MVs) is the final GPM merge list. The generation of the initial merge list is the same (i.e., the normal merge list generation without any candidate reordering) except that when generating the initial merge list for larger blocks (i.e., blocks with the extraction process bypassed), the motion vector difference threshold for controlling whether a candidate can be added into the list is increased to one full sample distance.

Bi-directional optical flow (“BDOF”)-based motion vector refinement as in multi-pass Decoder-Side Motion Vector Refinement (“DMVR”) is applied when generating motion compensated prediction samples.

When GPM-MMVD is applied for a GPM partition and its base motion vector is bi-predictive, for low-delay pictures, the signaled MVD is applied on top of the list 0 and list 1 motion vector as in the existing merge MMVD design. For non-low-delay pictures, the bi-predictive motion vector is converted to a uni-predictive motion vector, and then MVD is applied.

According to GPM with inter and intra prediction, final prediction samples are generated by weighting inter predicted samples and intra predicted samples for each GPM-separated region. Inter predicted samples are derived by inter GPM, while intra predicted samples are derived by an intra prediction mode (“IPM”) candidate list and an index signaled from the encoder. The IPM candidate list size is pre-defined as 3. FIGS. 6A through 6C illustrate respective examples of the available IPM candidates: parallel angular mode against the GPM block boundary (Parallel mode), perpendicular angular mode against the GPM block boundary (Perpendicular mode), and Planar mode.

Furthermore, FIG. 6D illustrates GPM with intra and intra prediction, restricted to reduce signaling overhead for IPMs so that the intra prediction circuit of the hardware decoder need not be expanded. In addition, a direct motion vector and IPM storage on the GPM-blending area are introduced to further improve coding performance.

According to decoder-side intra mode derivation (“DIMD”) and neighboring mode based IPM derivation, Parallel mode is registered first. Therefore, at most two IPM candidates derived from the DIMD method and/or the neighboring blocks can be registered if a same IPM candidate is not already in the list. As for the neighboring mode derivation, there are five positions for available neighboring blocks at most, but they are restricted by the angle of GPM block boundary, according to Table 3 below.

| | Angle of GPM | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

The GPM block boundaries are those already used for GPM with template matching (GPM-TM).

GPM with intra prediction (“GPM-intra”) can be combined with GPM-MMVD. Template-based intra mode derivation (“TIMD”) is applied for IPM candidates of GPM-intra to further improve coding performance. Parallel mode can be registered first, and then IPM candidates of TIMD, DIMD, and neighboring blocks can follow.

According to implicit GPM, two integer blending matrices (W0 and W1) are derived from the template (one line above and one column left of the current coding block). Blending matrices are modelled as an affine linear function of the sample positions (x, y) in the current coding block: W0(x, y)=a·x+b·y+c and W1(x, y)=1−W0(x, y). The parameters (a, b, c) are derived from the template of the reference pictures using the same solver (MSE minimization) as the one used for Convolutional cross-component model (“CCCM”), Gradient Linear Model (“GLM”) or Gradient and location based convolutional cross-component model (“GL-CCCM”). A list of GPM motion candidate pairs is constructed from the regular GPM motion candidates and reordered by template cost.

The GPM implicit mode is signaled by a CU-level flag (gpm_implicit_flag). If gpm_implicit_flag is true, a merge-idx is coded to signal the pair of GPM motion candidates to be used. If gpm_implicit_flag is false, the regular GPM syntax elements are signaled.

ECM extends the VVC standard to to enable affine motion compensation (“AMC”) for GPM. Therefore, a GPM partition can be predicted by AMC inter-prediction, non-AMC inter-prediction or intra-prediction. In addition, a GPM partition predicted by AMC can be combined with the other GPM partition predicted by AMC inter-prediction, non-AMC inter-prediction, or intra-prediction.

When AMC inter-prediction is applied, a uni-prediction affine merge candidate list is constructed from the subblock-based merge candidate list after discarding sub-TMVP candidates, similar to the uni-prediction merge candidate list construction for GPM in VVC. AMC inter-prediction is performed for a GPM partition using the control point motion vectors (“CPMVs”) of a merge candidate in the uni-prediction affine merge candidate list. The length of the uni-prediction affine merge candidate list is signaled in SPS. When ARMC is applicable, the uni-prediction affine merge candidate list is reordered by template cost.

A gpm_affine_flag is signaled for each GPM partition to indicate whether AMC inter-prediction is applied for the GPM partition. A merge candidate index for the GPM partition is signaled using individual arithmetic context models depending on whether AMC inter-prediction or non-AMC inter-prediction is applied. AMC inter-prediction is not allowed for GPM-MMVD and GPM-TM.

According to the ECM extension of the VVC standard, GPM blending is not applied within the template area across the splitting line, and the template includes only one row left of the current coding block and one column above the current coding block. Therefore, after GPM generates final prediction samples with weighted average and all GPM split modes are reordered based on the TM costs, the lack of blending on the splitting line and the usage of only one row and column provides insufficient information. This leads to less accurate results from the reordering.

Therefore, example embodiments of the present disclosure provide improvements to template matching for geometric partitioning, including extensions of template size for template matching, application of template blending at a splitting line, reordering of partitioning modes by template matching cost and blending area width, and bitstream signaling of blending area width.

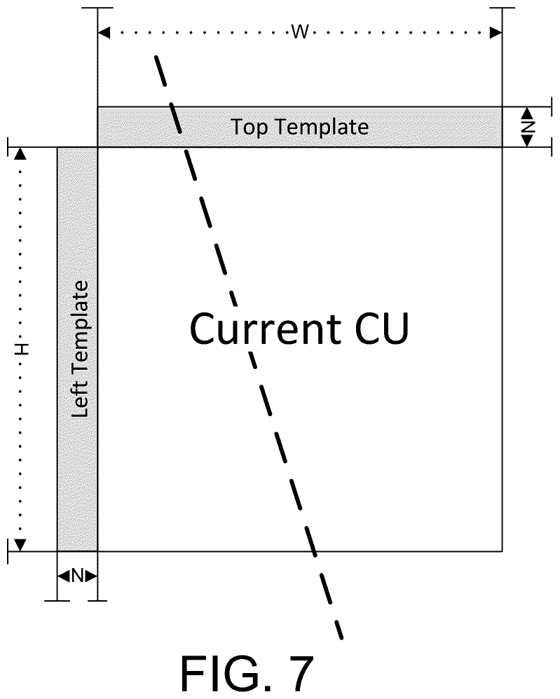

FIG. 7 illustrates extension of a template for template matching according to example embodiments of the present disclosure. The upper template and left template are extended in size to an integer N that is larger than 0. For example, N can be set to 2. All GPM split modes are reordered in ascending order based on the TM cost values, derived from a template including N columns left of the current coding block and N rows above the current coding block. In the case where N is set to 2, the template includes two columns left and two rows above.

By way of example, the value of N is a pre-defined value and is not signaled in a bitstream. By way of another example, the number of columns left of the current coding block can be different from the number of rows above the current coding block, e.g., a template can include four columns left but only two rows above. As the samples of the rows above the current coding block are more expensive to be stored in the line buffer, a template may include fewer rows above a current coding block than columns left of the current coding block.

According to further example embodiments of the present disclosure, blending is applied within the template area across the splitting line. According to existing GPM design, within the current coding block, the predicted samples around the boundary of the two partitions are weighted averaged to get the final predicted samples. This process is called blending. The weights used in the weighted average are dependent on the distance from the boundary; the blending area width is determined by the encoder and signaled in the bitstream to the decoder; and there are five options for a blending area width.

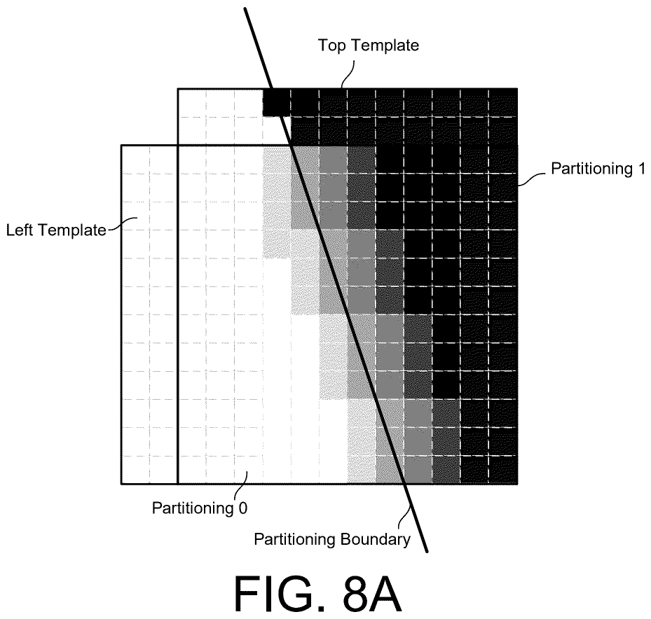

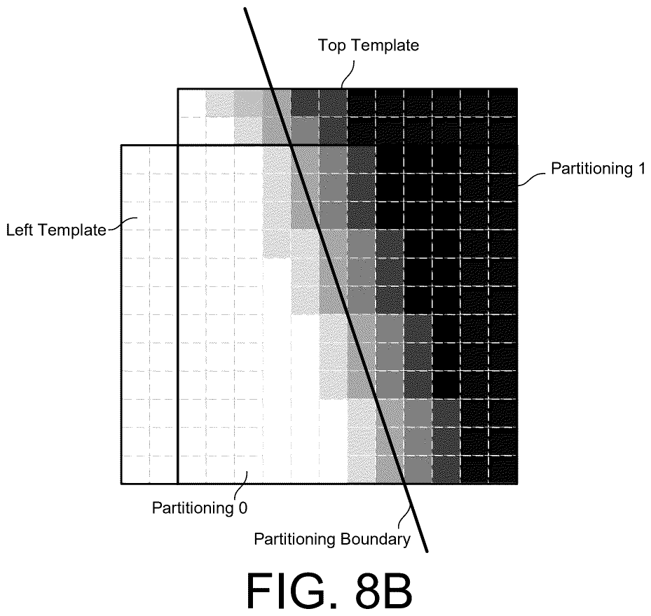

However, for the template area, the two partitions of the template are directly stitched without blending. FIG. 8A illustrates blending for geometric partitioning according to the VVC standard and ECM extensions to VVC, wherein white samples and black samples, respectively, are non-blended samples of the two respective partitioned parts, and gray samples are blended samples, with different weights illustrated by different shades of gray.

FIG. 8B illustrates template blending at a splitting line according to example embodiments of the present disclosure. The gray samples are within the template area around the splitting line and are also blended similarly to the samples within the coding block around the splitting line. Samples of the template are blended by a similar process to the samples within the coding block around the splitting line.

According to an example embodiment, when reordering partitioning modes by TM cost, template blending on the samples within template area around the splitting line is applied, with a fixed blending area width. TM cost is used to reorder the partitioning modes. The fixed blending area width can be set to N and N can be an integer which may be 1, 2, 4, 8, 16 or other values, preferably power of 2. It is noted that the value N may be a pre-defined value without signaling in the bitstream.

According to another example embodiment, when reordering partitioning modes by TM cost, template blending is applied to template samples around the splitting line. Here, the blending area width is not fixed but adaptive. Subsequently, TM cost is used to reorder the partitioning modes. By way of example, the blending area width can be decided by the encoder according to rate-distortion cost and signaled in the bitstream to the decoder. By way of another example, the blending area width can be set equal to the blending area width of the current coding block. Presently, a VVC-standard encoder configures one or more processors to determine the blending area width of the coding block and signal the blending area width by transmitting an index in a bitstream. Additional signaling is not needed, as the blending area width always follows the coding block blending area width which is already indicated by the index signaled in the bitstream.

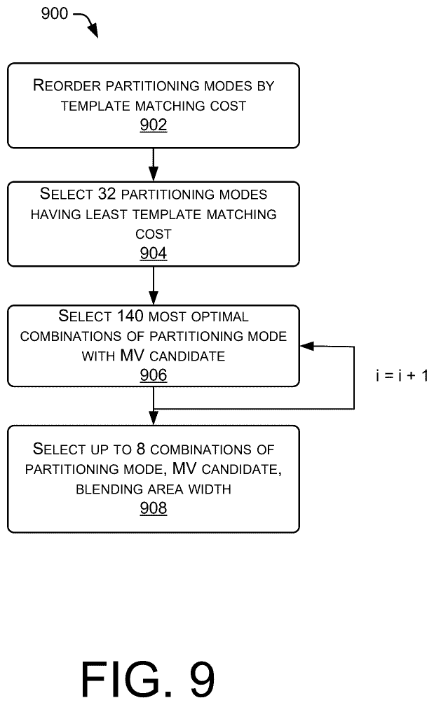

FIG. 9 illustrates a flowchart of reordering partitioning modes according to VVC extended by ECM. Presently, in GPM, a coding block is divided into two partitions. At a step 902, GPM partitioning modes are reordered for a current coding block by template matching cost. At a step 904, thirty-two partitioning modes having least TM cost are selected.

At a step 906, 140 most optimal combinations of a partitioning mode of the thirty-two partitioning modes with an MV candidate of the GPM motion candidate list are selected, based on a bitrate estimation and a distortion (measured by, for example, sum of absolute difference (“SAD”)) between a template of the current coding block and a template of a reference picture. While calculating template distortion, no blending is applied on the samples of the template. At a step 908, up to eight combinations of a partitioning mode of the thirty-two partitioning modes with an MV candidate of the GPM motion candidate list and a blending area width are selected, based on blending at the splitting line within the current coding block.

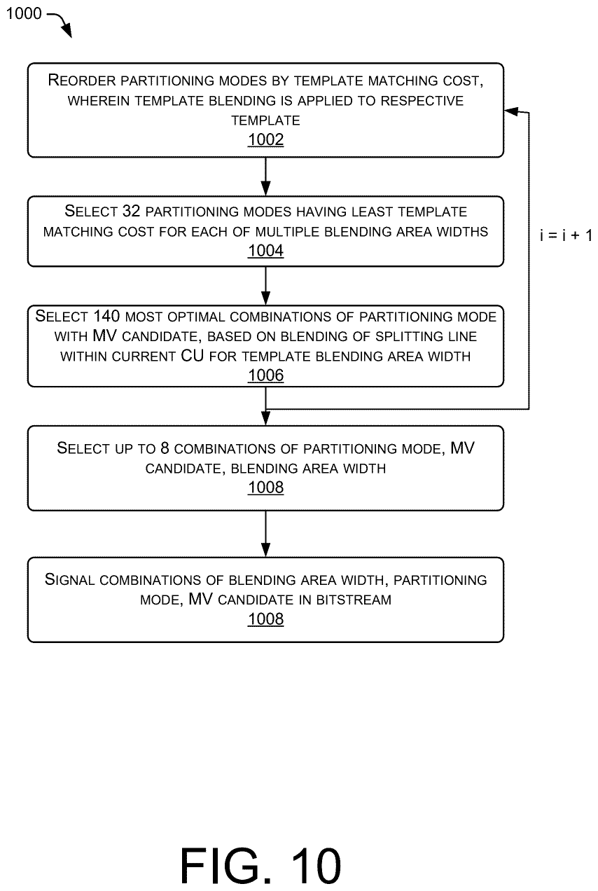

FIG. 10 illustrates a flowchart of reordering partitioning modes by a VVC-standard encoder according to example embodiments of the present disclosure. At a step 1002, a VVC-standard encoder configures one or more processors of a computing system to reorder GPM partitioning modes for a current coding block by template matching cost wherein template blending is applied to a respective template for each of multiple blending area widths. At a step 1004, a VVC-standard encoder configures one or more processors of a computing system to select thirty-two partitioning modes having least template cost for each of multiple blending area widths, wherein template blending is applied to a respective template for each of multiple blending area widths. In other words, for each possible blending area width, the thirty-two partitioning modes having least template cost are selected. Given five different blending area widths, 32×5=160 partitioning modes are selected in total. At a step 1006, a VVC-standard encoder configures one or more processors of a computing system to select more than thirty-two and up to 140 most optimal combinations of a partitioning mode of the 160 partitioning modes with an MV candidate of the GPM motion candidate list based on a bitrate estimation and a distortion between a template of the current coding block and a template of a reference picture, based on blending at the splitting line for each respective blending area width within the current coding block. At a step 1008, the VVC-standard encoder configures one or more processors of a computing system to select up to eight combinations of a partitioning mode of the more than thirty-two and up to 140 partitioning modes with an MV candidate of the GPM motion candidate list and a blending area width. At a step 1010, the VVC-standard encoder configures one or more processors of a computing system to signal a combination of a blending area width, a partitioning mode, and an MV candidate of the GPM motion candidate list in a bitstream.

To reduce computation cost, in step 1004 where thirty-two partitioning modes are selected, template blending is not applied. The thirty-two selected partitioning modes are then reordered by template costs wherein template blending is applied. Thus, for different blending area widths, the thirty-two partitioning modes are ordered differently. Given five different blending area widths, five different queues of thirty-two partitioning modes, each having a different partitioning mode order, are determined.

For each specific blending area width, more than thirty-two and up to the best 140 combinations of partitioning modes and MV candidates are selected, with template blending applied during selection. In total, up to 140×5=700 combinations are selected. In step 1006, when calculating template distortion of the current coding block, template blending follows a blending area width of the current coding block. Then, eight combinations are selected from the 700 combinations, and rate-distortion optimization (“RDO”) is applied to select a final combination from the eight combinations.

According to another example embodiment, the thirty-two partitioning modes are selected based on a template without blending. More than thirty-two and up to 140 combinations of partitioning modes and motion candidates are then selected based on a template without blending. For each specific blending area width, the respective thirty-two modes are then reordered by template cost with template blending. In step 1006, when calculating template distortion of the current coding block, template blending follows a blending area width of the current coding block. Then, eight combinations are selected from the up to 140 combinations, and RDO is applied to select a final combination from the eight combinations.

According to a further example embodiment, the thirty-two partitioning modes are selected with template blending, based on a template with blending area width fixed to 4. These thirty-two modes are then reordered with template blending, based on different blending area widths. Subsequently, for each specific blending area width, more than thirty-two and up to 140 combinations of partitioning modes and motion candidates are selected based on template blending. In total, up to 140×N combinations are selected, where N is the number of different blending area widths. In step 1006, when calculating the distortion of the current coding block, template blending follows a blending area width of the current coding block. Then, eight combinations are selected from all the combinations, and RDO is applied to select a final combination from the eight combinations.

According to a further example embodiment, the thirty-two partitioning modes are selected with template blending, based on a template with blending area width fixed to 4. Then, more than thirty-two and up to 140 combinations of partitioning modes and motion candidates are selected based on a template without sample blending. Then, for each specific blending area width, the respective thirty-two modes are reordered with the template blending. In step 1006, when calculating template distortion of the current coding block, template blending follows a blending area width of the current coding block. Then, eight combinations are selected from all the combinations, and RDO is applied to select a final combination from the eight combinations.

In another embodiment, the thirty-two partitioning modes are selected based on a template without blending. These thirty-two modes are then reordered with template blending. Thus, for different blending area widths, the thirty-two partitioning modes are ordered differently. Additionally, a blending area width of 0 is also treated herein as a distinct blending area width. Subsequently, for each blending area width, more than thirty-two and up to 140 combinations of partitioning modes and motion candidates are selected. In total, up to 140×N combinations are selected, where N is the number of different blending area width including 0. In step 1006, when calculating template distortion of the current coding block, template blending follows a blending area width of the current coding block. Then, eight combinations are selected from all the combinations, and RDO is applied to select a final combination from the eight combinations.

According to the example embodiments described above, template blending within coding block follows a blending area width of the coding block, so blending area width is not signaled, since it shares the same index as the coding block blending area width.

Alternatively, the blending area width for template blending is different from the blending area width within a coding block. In these cases, the blending area width can be independent of blending area width within a coding block. Therefore, further example embodiments of the present disclosure provide signaling of template adaptive blending.

According to an example embodiment, blending area widths are reordered by template cost. Smaller indices, with fewer bits, are assigned to blending area widths introducing smaller template costs.

According to another example embodiment, blending area widths are reordered by TM cost. After reordering, an index is signaled to indicate the use of blending area width. If the first blending area width is chosen, 1 bit is transmitted. if the other candidate is chosen, 3 bits are transmitted.

According to another example embodiment, one flag is signaled to indicate whether the blending area width is equal to a particular value N. If it is not equal to N, other blending area widths are reordered by TM cost, and an index is signaled to indicate a blending area width other than N. The blending area widths having less TM cost has smaller indices and thus costs fewer bits. In this example, N is the preferred blending area width and thus has high priority in the signaling. By way of example, N can be 4.

According to another example embodiment, blending area width is reordered by TM cost. However, to give a high priority to a particular blending area width N, in the TM cost calculation, TM cost of blending area width N is multiplied by a factor which is less than 1 (e.g., 0.9 or 0.8). After reordering, an index is signaled to indicate the usage of blending area width. The blending area widths having smaller TM cost have smaller indices and thus costs fewer bits. For example, given five different blending area widths, if the first candidate is chosen, 1 bit is transmitted, and if the other candidate is chosen, 3 bits are transmitted. Alternatively, 1 bit is used if first candidate is chosen, 2 bits are used if the second candidate is chosen, 3 bits are used if the third candidate is chosen, and 4 bits are used if the fourth or the fifth candidate is chosen.

Additionally, as described above with reference to step 1010, a partitioning mode and an MV candidate combined with the signaled blending area width are also signaled in the bitstream. The partitioning mode and/or the MV candidate can be signaled following the blending area width in the bitstream.

By way of further examples, blending area width and partitioning mode signaling are combined. An index is signaled to jointly indicate the partitioning mode and the blending area width, and the indicated blending area width is both applied on a coding block and a template. For example, different combinations of partitioning modes and blending area widths are checked and the top 100 combinations are selected based on a template matching cost, and when calculating the template matching cost, the corresponding blending area width is applied in the template. Then, an index is signaled using Golomb-Rice code to indicate the one of these 100 combinations which is used.

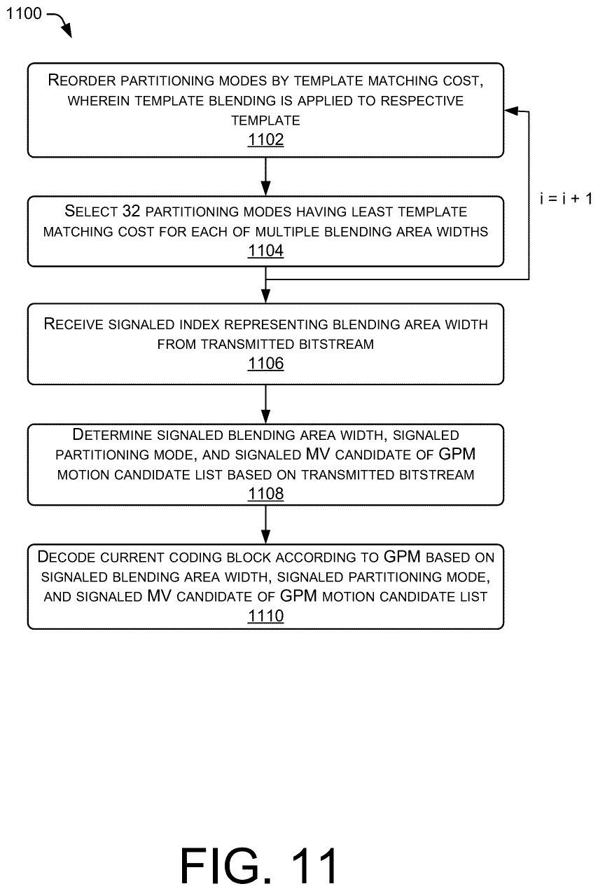

FIG. 11 illustrates a flowchart of reordering partitioning modes by a VVC-standard decoder according to example embodiments of the present disclosure. At a step 1102, a VVC-standard decoder configures one or more processors of a computing system to reorder GPM partitioning modes for a current coding block by template matching cost wherein template blending is applied to a respective template for each of multiple blending area widths. At a step 1104, a VVC-standard decoder configures one or more processors of a computing system to select thirty-two partitioning modes having least template cost for each of multiple blending area widths, wherein template blending is applied to a respective template for each of multiple blending area widths. In other words, for each possible blending area width, the thirty-two partitioning modes having least template cost are selected. Given five different blending area widths, 32×5=160 partitioning modes are selected in total. At a step 1106, a VVC-standard decoder configures one or more processors of a computing system to receive an index signaling a blending area width from a transmitted bitstream. At a step 1108, a VVC-standard decoder configures one or more processors of a computing system to determine a blending area width, a partitioning mode, and an MV candidate of the GPM motion candidate list based on the transmitted bitstream. At a step 1110, the VVC-standard decoder configures one or more processors of a computing system to decode a current coding block according to GPM based on the blending area width, the partitioning mode, and the MV candidate of the GPM motion candidate list.

Steps 1102 and 1104 can proceed according to any embodiments described with respect to steps 1002 and 1004 with reference to FIG. 10 above. Signaled blending area widths, signaled partitioning modes, and signaled MV candidates can be signaled in a transmitted bitstream according to any embodiments described with respect to step 1010 with reference to FIG. 10 above.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 12 illustrates an example system 1200 for implementing the processes and methods described above for implementing template matching for geometric partitioning.

The techniques and mechanisms described herein may be implemented by multiple instances of the system 1200 as well as by any other computing device, system, and/or environment. The system 1200 shown in FIG. 12 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1200 may include one or more processors 1202 and system memory 1204 communicatively coupled to the processor(s) 1202. The processor(s) 1202 may execute one or more modules and/or processes to cause the processor(s) 1202 to perform a variety of functions. In some embodiments, the processor(s) 1202 may include a central processing unit (“CPU”), a graphics processing unit (“GPU”), both CPU and GPU, or other processing units or components known in the art. Additionally, each of the processor(s) 1202 may possess its own local memory, which also may store program modules, program data, and/or one or more operating systems.

Depending on the exact configuration and type of the system 1200, the system memory 1204 may be volatile, such as RAM, non-volatile, such as ROM, flash memory, miniature hard drive, memory card, and the like, or some combination thereof. The system memory 1204 may include one or more computer-executable modules 1206 that are executable by the processor(s) 1202.

The modules 1206 may include, but are not limited to, one or more of an encoder 1208 and a decoder 1210.

The encoder 1208 may be a VVC-standard encoder implementing any, some, or all aspects of example embodiments of the present disclosure as described above, and executable by the processor(s) 1202 to configure the processor(s) 1202 to perform operations as described above.

The decoder 1210 may be a VVC-standard encoder implementing any, some, or all aspects of example embodiments of the present disclosure as described above, executable by the processor(s) 1202 to configure the processor(s) 1202 to perform operations as described above.

The system 1200 may additionally include an input/output (“I/O”) interface 1240 for receiving image source data and bitstream data, and for outputting reconstructed pictures into a reference picture buffer or DPB and/or a display buffer. The system 1200 may also include a communication module 1250 allowing the system 1200 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-11. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
reordering Geometric Partitioning Mode (“GPM”) partitioning modes for a current coding block by template matching cost, wherein template blending is applied to a respective template based on a blending area width;
selecting, for each of a plurality of blending area widths, a respective plurality of ordered GPM partitioning modes having least template matching cost;
selecting a combination of a blending area width, a partitioning mode of the pluralities of ordered GPM partitioning modes, and an MV candidate of a GPM motion candidate list based on blending at a splitting line for a blending area width of the plurality of blending area widths within the current coding block; and
signaling the selected combination of the blending area width, the partitioning mode of the pluralities of ordered GPM partitioning modes, and the MV candidate of the GPM motion candidate list in a bitstream.

2. The computing system of claim 1, wherein the plurality of blending area widths comprises five blending area widths, and the pluralities of ordered GPM partitioning modes comprises five pluralities of ordered GPM partitioning modes.

3. The computing system of claim 1, wherein selecting, for each of a plurality of blending area widths, a respective plurality of ordered GPM partitioning modes having least template matching cost comprises:
ordering GPM partitioning modes by template matching cost while applying template blending; and
selecting a plurality of the ordered GPM partitioning modes having least template matching cost.

4. The computing system of claim 1, wherein selecting, for each of a plurality of blending area widths, a respective plurality of ordered GPM partitioning modes having least template matching cost comprises:
selecting a plurality of GPM partitioning modes by template matching cost while applying template blending.

5. The computing system of claim 1, wherein the operations further comprise selecting, for each of the plurality of blending area widths, a respective plurality of combinations of a blending area width, a partitioning mode of the pluralities of ordered GPM partitioning modes, and an MV candidate of a GPM motion candidate list based on blending at a splitting line within the current coding block.

6. The computing system of claim 5, wherein the plurality of blending area widths comprises five blending area widths, and each respective plurality of combinations comprises more than 32 combinations.

7. The computing system of claim 5, wherein each partitioning mode and each MV candidate is selected without template blending.

8. The computing system of claim 5, wherein each partitioning mode and each MV candidate is selected while applying template blending.

9. The computing system of claim 1, wherein selecting a combination of a blending area width, a partitioning mode of the pluralities of ordered GPM partitioning modes, and an MV candidate of a GPM motion candidate list based on blending at a splitting line for a blending area width of the plurality of blending area widths within the current coding block comprises:
selecting a plurality of combinations across the pluralities of combinations; and
selecting a combination from the plurality of combinations.

10. The computing system of claim 1, wherein signaling the blending area width comprises signaling an index which is smaller for a blending area width having a smaller template matching cost.

11. The computing system of claim 1, wherein signaling the blending area width comprises signaling an index which indicates both a blending area width and a partitioning mode.

12. The computing system of claim 1, wherein the partitioning mode of the pluralities of ordered GPM partitioning modes and the MV candidate of the GPM motion candidate list is signaled after the blending area width in the bitstream.

13. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
reordering Geometric Partitioning Mode (“GPM”) partitioning modes for a current coding block by template matching cost, wherein template blending is applied to a respective template based on a blending area width;
selecting, for each of a plurality of blending area widths, a respective plurality of ordered GPM partitioning modes having least template matching cost;
determining a blending area width, a partitioning mode, and an MV candidate of the GPM motion candidate list based on at least one index received from a transmitted bitstream and based on the pluralities of ordered GPM partitioning modes; and
decode a current coding block according to GPM based on the determined blending area width, the determined partitioning mode, and the determined MV candidate of the GPM motion candidate list.

14. The computing system of claim 13, wherein the plurality of blending area widths comprises five blending area widths, and the pluralities of ordered GPM partitioning modes comprises five pluralities of ordered GPM partitioning modes.

15. The computing system of claim 13, wherein selecting, for each of a plurality of blending area widths, a respective plurality of ordered GPM partitioning modes having least template matching cost comprises:
ordering GPM partitioning modes by template matching cost while applying template blending; and
selecting a plurality of the ordered GPM partitioning modes having least template matching cost.

16. The computing system of claim 13, wherein the at least one index received from a transmitted bitstream comprises an index which indicates partitioning mode or indicates an MV candidate of a GPM motion candidate list following a flag which indicates a blending area width in the bitstream.

17. A non-transitory computer-readable storage medium storing a bitstream associated with a video sequence, the bitstream comprising:
one or more flags or indices indicating:
a combination of a blending area width, a Geometric Partitioning Mode (“GPM”) partitioning mode, and an MV candidate of a GPM motion candidate list to be applied, by one or more processors of a computing system configured by an entropy decoder, to decoding a current coding block according to GPM.

18. The non-transitory computer-readable storage medium of claim 17, wherein the one or more flags or indices comprises an index which is smaller for a blending area width having a smaller template matching cost.

19. The non-transitory computer-readable storage medium of claim 17, wherein the one or more flags or indices comprises a flag which indicates both a blending area width and a partitioning mode.

20. The non-transitory computer-readable storage medium of claim 17, wherein an index which indicates partitioning mode or indicates an MV candidate of a GPM motion candidate list follows a flag which indicates a blending area width in the bitstream.
